(19) United States
(12) Patent Application Publication
(10) Pub. No.: US 2015/0063718 A1
(43) Pub. Date: Mar. 5, 2015

(54) TECHNIQUES FOR ENHANCING LOW-LIGHT IMAGES

(71) Applicant: QUALCOMM Incorported, San Dieog, CA (US)

(72) Inventors: William Edward MANTZEL, San Diego, CA (US); Ramin Rezaiifar, Del Mar, CA (US); Piyush Sharma, San Diego, CA (US)

(73) Assignee: QUALCOMM Incorported, San Diego, CA (US)

(21) Appl. No.: 14/254,788

(22) Filed: Apr. 16, 2014

Related U.S. Application Data
(60) Provisional application No. 61/872,588, filed on Aug. 30, 2013.
(60) Provisional application No. 61/937,787, filed on Feb. 10, 2014.

(51) Int. Cl. G06T 5/50

(52) U.S. Cl. CPC G06T 5/50; G06T 2207/20221
USPC 382/274

(57) ABSTRACT

Techniques are described for enhancing quality of a first image that is captured in a low-light environment. In one embodiment, a second image is generated by brightening a plurality of pixels in the first image based on a predefined criteria. A third image is generated using an edge-preserving noise reduction algorithm based on the second image. Further, a composite image is generated by obtaining a weighted average of the first image and the third image. The techniques described herein can be applied to an image and/or to each frame of a video that is captured in low-light environments.

### CROSS-REFERENCE TO RELATED APPLICATIONS

The present application claims priority to Provisional Application. No. 61/872,588, entitled “Method and Apparatus for enhancing low-light videos,” filed Aug. 30, 2013, and Provisional Application No. 61/937,787, entitled “Method and Apparatus for enhancing low-light videos,” filed Feb. 10, 2014, both of which are assigned to the assignee hereof and expressly incorporated by reference herein in their entirety.

TECHNICAL FIELD

The present disclosure relates generally to digital images and/or videos, and in particular, to enhancing quality of images and/or videos that are captured in low light environments.

### BACKGROUND

Generally speaking, capturing videos and/or images in low-light environments is challenging. One possible solution for capturing single images in low-light conditions is to use a flash. However, it may not be possible to use a strong light source (such as a flash) while capturing videos in low-light environments. The reason might be that the strong light source can drain battery of the video-camera very quickly. There is a need in the art for techniques to enable a device to capture videos and/or images in low-light conditions.

### SUMMARY

Certain embodiments present a method for enhancing quality of a first image that is captured in a low-light environment. The method generally includes, in part, generating a second image by brightening a plurality of pixels in the first image based on a predefined criteria, and generating a third image using an edge-preserving noise reduction algorithm based on the second image. In one embodiment, the predefined criteria includes one or more look-up tables for mapping at least one of color or brightness values of the first image to the second image.

In one embodiment, the method further includes, generating a composite image by calculating a weighted average of the first image and the third image. In one embodiment, the method includes, calculating at least one weight corresponding to each pixel based on average intensity in a neighborhood around the pixel in the first image. The at least one weight is used in the weighted average of the first image and the third image. The at least one weight has a value between zero and one, which is calculated based on a monotonically increasing function of the average intensity in the neighborhood around the pixel.

In one embodiment, the at least one weight is calculated for pixels taken from a blurred and/or downsized version of the first image. For certain embodiments, the method is applied on a plurality of first images and the one or more look-up tables are adapted for each of the plurality of first images based on brightness of an input scene.

In one embodiment, generating the third image includes, in part, generating an edge map of the second image, and generating the third image by obtaining a weighted average of the second image and a fourth image based at least on the edge map. The fourth image is generated by blurring the second image. In one embodiment, for each pixel in the second image, a weight corresponding to the second image is determined based on the edge map. The weight is larger than 0.5 if the pixel represents an edge, and is smaller than 0.5 if the pixel is part of a smooth area in the second image.

Certain embodiments present an apparatus for enhancing quality of a first image that is captured in a low-light environment. The apparatus generally includes, in part, means for generating a second image by brightening a plurality of pixels in the first image based on a predefined criteria, and means for generating a third image using an edge-preserving noise reduction algorithm based on the second image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example high level block diagram of an image quality enhancing technique, in accordance with certain embodiments of the present disclosure.

FIG. 2 illustrates an example block diagram of an image processing technique, in accordance with certain embodiments of the present disclosure.

FIG. 3 illustrates an example mixing mask weight value as a function of brightness of a pixel, in accordance with certain embodiments of the present disclosure.

FIG. 4 illustrates example operations that may be performed by a device to enhance quality of images and/or videos, in accordance with certain embodiments of the present disclosure.

FIGS. 5A and 5B show an example video frame that is taken with a regular camera, and the same frame after being processed with an image enhancing technique, respectively, in accordance with certain embodiments of the present disclosure.

FIGS. 6A and 6B show an example video frame that is taken with a regular camera, and the same frame after being processed with an image enhancing technique, respectively, in accordance with certain embodiments of the present disclosure.

FIG. 7 describes one potential implementation of a device which may be used to enhance quality of images and/or videos, according to certain embodiments.

### DETAILED DESCRIPTION

Certain embodiments present a technique for enhancing quality of videos and/or images that are captured in low-light environments by processing the captured video frames and/or images. In this document, the term “image” is used to refer to a photograph captured by a camera, each of the frames in a video, and/or any other type of visual data captured from a scene, all of which fall within the teachings of the present disclosure.

In one embodiment, quality of an image is improved by brightening and/or de-noising the image. Quality of an image may refer to the visual perception of the image in terms of its sharpness and the level of detail that is visible in the image. Looking into the nature. Owls can see details of their surroundings in dark. One of the motivations of the present disclosure is to develop a technique that does not require a strong light source (such as a flash) for capturing images and/or videos in low-light environments with reasonable quality (similar to the processing that may be done in an Owl's eye).

Generally, it may be difficult to resolve detail in a video that is captured in low-light environments. One possible solution to process the captured video frames and brighten up each of the dark pixels. However, brightening often results in an undesirable magnification of noise (including, for example, quantization noise). Another possible solution is to use video cameras that are very sensitive to light (e.g., High ISO videos). However, High ISO videos may also result in high noise levels.

Other brightening approaches include histogram equalization of video frames. However, using histogram equalization results in a washed-out image with noise significantly boosted. Another possible approach is to use a special sensor that is able to capture more light in a shorter exposure time. For example, instead of capturing a video with red-green-blue-green (RGBG) Bayer pattern, one may capture a video using red-green-blue-clear (RGBC), or RCBC. However, this approach increases cost of the video cameras.

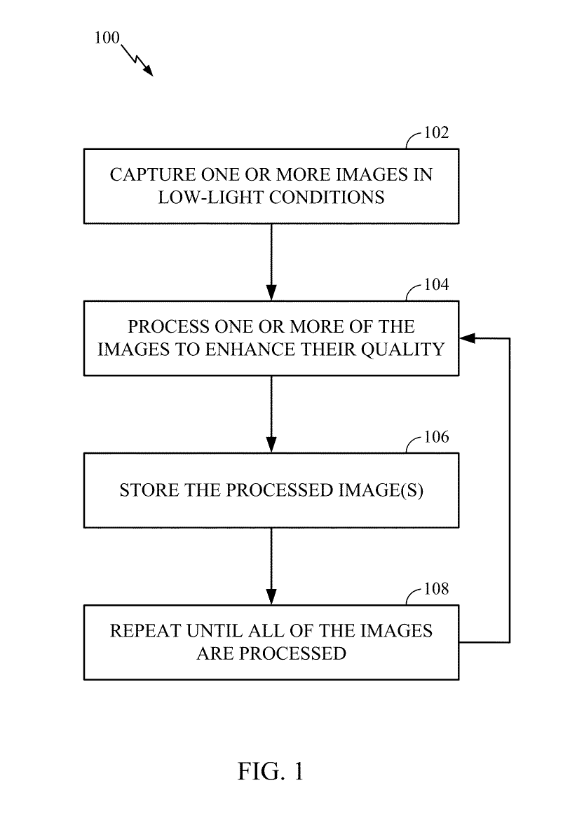

FIG. 1 illustrates an example high level block diagram of an image quality enhancing technique, in accordance with certain embodiments of the present disclosure. A device captures one or more images (e.g. photographs, video frames, etc.) in low-light conditions (at 102). The device processes one or more of the captured images to enhance their quality (at 104). For example, the device may brighten the images, reduce the amount of noise in the images and/or perform other types of processing on the images. At 106, the device stores the processed image and processes the rest of the images (108) until all of the images are processed.

One embodiment brightness one or more dark pixels in an image based on a criteria. The dark pixels are identified by analyzing brightness of each pixel. In one embodiment, each pixel in the image is brightened depending on the original level of brightness in the pixel. For example, a pixel that is originally dark may be brightened more compared to a pixel that is originally bright. In one embodiment, the image is brightened such that a non-decreasing continuity and a reasonable level of contrast is maintained in the brightened image.

In one embodiment, one or more look-up tables are defined for brightening the input images. As an example, a length-256 brightening lookup table is calculated to map each input integer value between 0 and 255 to a brightened value based on a predefined rule. In general, the look up tables can be defined in advance and stored on the device. Alternatively, brightness values corresponding to each brightened pixel can be calculated based on a formula.

For certain embodiments, the look-up tables can be adapted on a frame-by-frame basis in a video according to the brightness of the input scene. For example, if a scene from which a video is captured is sufficiently bright, the pixels in the video may not need to be brightened (or may need a little brightening depending on the original level of light in the environment). On the other hand, if the scene is originally dark, the pixels in the video need more brightening.

For certain embodiments, similar or different look-up tables can be defined corresponding to different channels. For example, one or more look up tables can be defined corresponding to each of the channels in RGB color space, the Y channel (e.g., brightness channel) in YUV color space, or the V channel in HSV model.

In the present disclosure, YUV and RGB (red-green-blue) refer to color spaces representing information about each pixel in the image. In addition, HSV (Hue-Saturation-Value) refers to a cylindrical-coordinate representation of points in the RGB color model. It should be noted that the present disclosure is not limited to any specific representation. One of ordinary skill in the art would readily understand that the image quality enhancing technique as described herein can be applied to any type of representation without departing from the scope of the present disclosure.

In one embodiment, a weighted combination of the original and brightened frames may be generated. The weights corresponding to each of the original and the brightened frames are defined based on the original frame in order to adapt the output frames' brightness intensities.

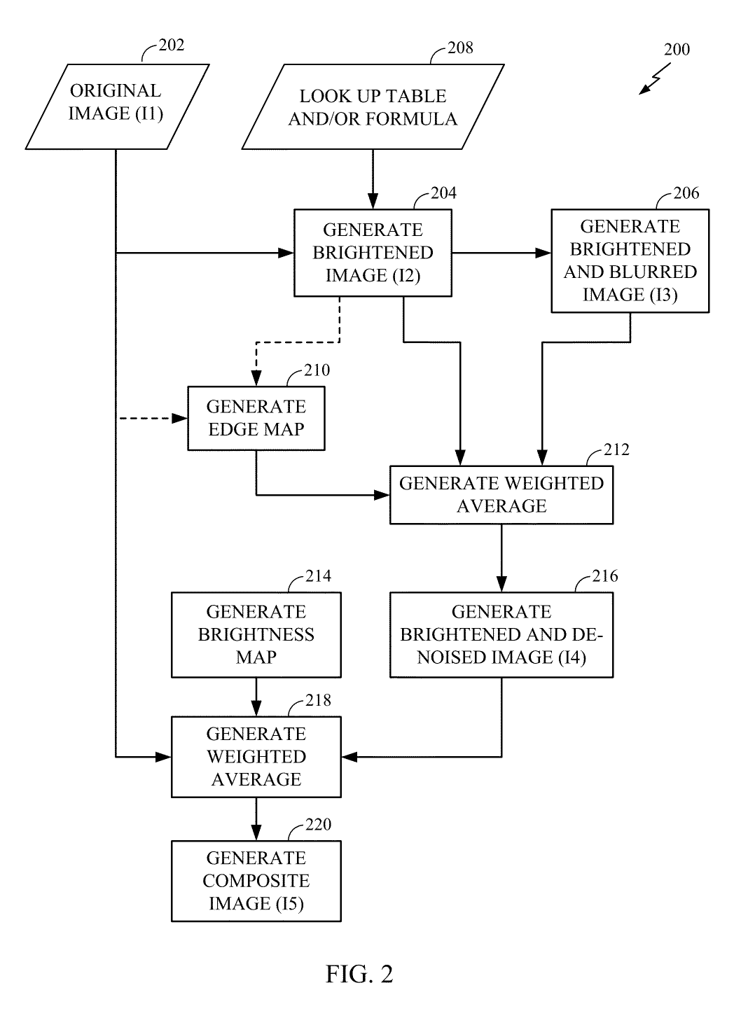

FIG. 2 illustrates an example block diagram of an image quality enhancing technique, in accordance with certain embodiments of the present disclosure. As described earlier, a brightened image 204 can be generated based on the original image 202 using one or more lookup tables and/or based on a formula 208. Brightening an image may result in an increased noise level in the image. In one embodiment, the brightened image may further be processed to remove/reduce noise in the image (e.g., to de-noise). An edge-preserving noise reduction technique is described herein that takes the brightened image as an input and produces a bright image with significantly reduced noise.

In one embodiment, a brightened and de-noised image 216 is generated by applying the edge-preserving noise reduction technique to the brightened image 204, and a blurred version of the brightened image (e.g., brightened-blurred image 206). For example, a pixel-wise weighted average 212 of the brightened image 204 and the brightened-blurred image 206 is calculated. The weighted average is constructed for each pixel coordinate (x,y), as follows:

I₄(x,y)=W₁(x,y)×I₂(x,y)+(1−W₁(x,y))×I₃(x,y),

where I₂ is the brightened image, I₃ is the brightened-blurred image, I₄ is the resulting brightened-denoised image, and W₁ is the de-noising mixing mask with values between zero and one.

In one embodiment, the de-noising mixing mask W₁ is obtained as a function of the edge-map values. As an example, higher edge-map values (e.g., representing an edge) correspond to higher de-noising mixing mask values. The edge-map 210 can be generated based either on the original image 202 or the brightened image 204. In one embodiment, the edge-map 210 is generated by applying a blurred magnitude of a difference of Gaussian filter to the image. In one embodiment, the difference of Gaussian operation may be computed on a down-sampled (e.g., downsized) version of the image, or on the image itself.

As an example, for the pixels that are located on the edges, the brightened image 204 is given a higher weight than the blurred version 206 of the brightened image (e.g., 0.5<W₁≦1). In addition, the weights are selected such that the pixels in the smooth regions are chosen from the brightened-blurred image (e.g., 0≦W₁<0.5). Therefore, for the pixels that are located on the smooth regions, the blurred version of the brightened image is given a higher weight than the brightened image. In addition, for the intermediate pixels (e.g., pixels between the sharp edges and the smooth regions), the weights are chosen such that these pixels represent a weighted average between the corresponding pixels in the brightened image 204 and the brightened-blurred image 206. For example, the weights may increase linearly for the pixels that are between the sharp edges and the smooth regions. Therefore, by moving away from an edge, weight of the brightened image decreases and weight of the brightened-blurred image increases. It should be noted linearly increasing weights are mentioned only as an example, and any other relation may be defined for generating the weights without departing from the scope of the present disclosure.

As mentioned earlier, the noise reduction technique as described herein preserves edges in the image while reducing noise. Therefore, unlike other noise reduction schemes in the art, the image does not appear washed-out after noise reduction. In one variation of the noise reduction technique, the weights can be generated such that the convex combination of the brightened image and the brightened-blurred image favors the sharp version (e.g., the brightened image) over the brightened-blurred image in brighter regions (e.g., where noise reduction is not as necessary).

It should be noted FIG. 2 only illustrates an example order between the brightening, noise reduction, weighted average and other processing that is performed on the image. One of ordinary skill in the art would readily appreciate that the order between different steps in FIG. 2 can be varied without departing from the teachings of the present disclosure. For example, in one embodiment, the de-noising step can be performed on an image before brightening the image. Therefore, the de-noising technique is applied to a frame of a video (e.g., an image) that is captured in low-light conditions to remove and/or reduce the noise in the image before brightening the pixels in the image.

In some cases, brightening and de-noising an image may cause unwanted artifacts. Therefore, in one embodiment, the brightened-denoised image may be adjusted to revert back towards the original image, if the original image had an acceptable and/or better quality. Certain embodiments selectively brighten an image based on a brightness map 214 of the original image using a local tone mapping (LTM) technique. The LTM technique adjusts brightness of each pixel in an image by leveraging sharpness of the original image to generate a composite image 220. The brightness map 214 may be obtained, for example, by blurring the original image.

In one embodiment, the composite image 220 is generated as a pixel wise weighted average 218 between the original image 202 and the brightened-denoised image 216, as follows:

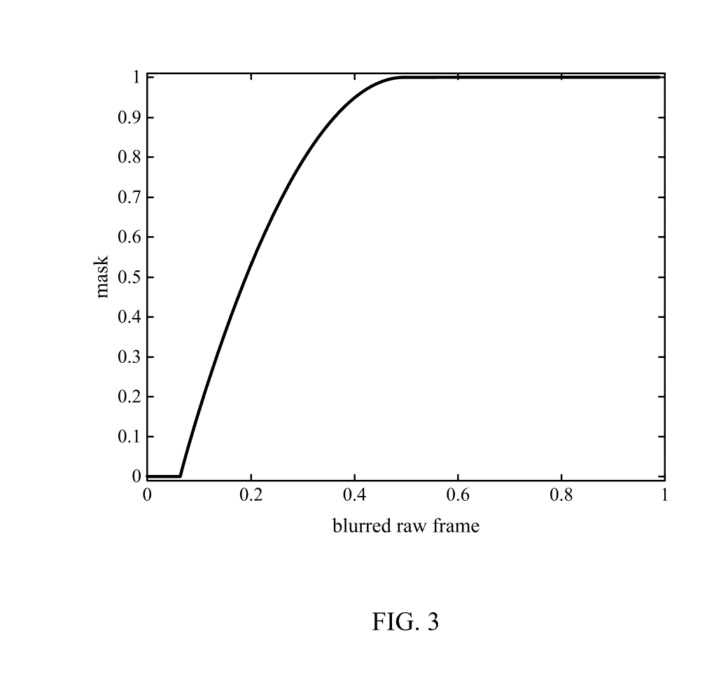

I₅(x,y)=W₂(x,y)×I₁(x,y)+(1−W₂(x,y))×I₄(x,y),

where I₁ is the original image, I₄ is the brightened-denoised image, I₅ is the resulting composite image, and W₂ is the LTM mixing mask. In one embodiment, the LTM mixing mask is computed as a function of brightness of the image (e.g., based on the brightness map values). The LTM mixing mask has values between zero and one, as illustrated in FIG. 3.

In one embodiment, the LTM mixing mask W₂ for a pixel may be close to one if the average intensity in a neighborhood around the corresponding pixel in the brightened image is high. In addition, the LTM mixing mask W₂ may be close to zero if the average intensity in a neighborhood around the corresponding pixel in the brightened image is low. In general, the LTM mixing mask may be described as a lookup-table and/or as a function of brightness of a pixel.

FIG. 3 illustrates an example mixing mask weight value as a function of brightness of a pixel, in accordance with certain embodiments of the present disclosure. In this example, the LTM mixing mask is an increasing function of brightness of the image. As illustrated, the LTM mixing mask increases as the brightness increases and is equal to one when brightness value is greater than 0.5.

In one embodiment, an LTM mixing mask is generated by blurring the original image. For example, the original image is blurred with a sigma equal to width of the image divided by 10 to generate a blurred image. Next, the LTM mixing mask is constructed from the blurred image based on the brightness of each pixel. As described earlier, the LTM mixing mask is used to merge the original image with the brightened-denoised image. For certain embodiments, the original image and the brightened-denoised image are merged either in one channel (e.g., Y channel), or in more than one channel (e.g., Luma and/or color channels). In one embodiment, the blurred image may be down-sampled to a smaller width (e.g., 128) to facilitate further processing, such as additional blurring and/or generating the look up table for the LTM mixing mask.

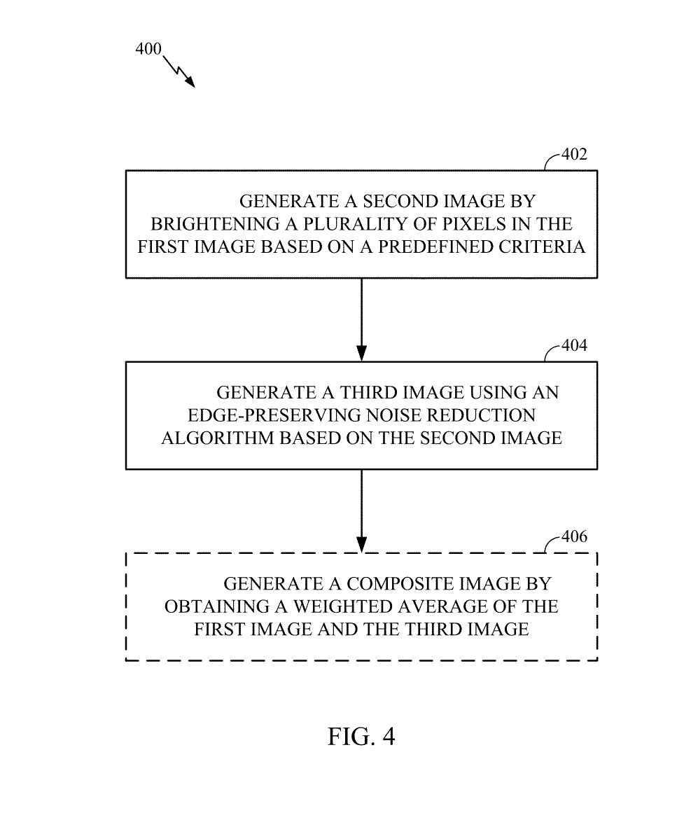

FIG. 4 illustrates example operations 400 that may be performed by a device to enhance quality of a first image that is captured in a low-light environment, in accordance with certain embodiments of the present disclosure. At 402, the device generates a second image by brightening a plurality of pixels in the first image based on a predefined criteria. In one embodiment, the predefined criteria include one or more look-up tables for mapping at least one of color or brightness values of the first image. At 404, the device generates a third image using an edge-preserving noise reduction algorithm based on the second image. In one embodiment, at 406, the device generates a composite image by calculating a weighted average of the first image and the third image.

In one embodiment, the device generates an edge-map (e.g., using difference of Gaussian filter) from the second (e.g., brightened) image. In another embodiment, the edge-map is generated from the first image (e.g., the original image). The edge-map may show where the edges of objects in the scene are located.

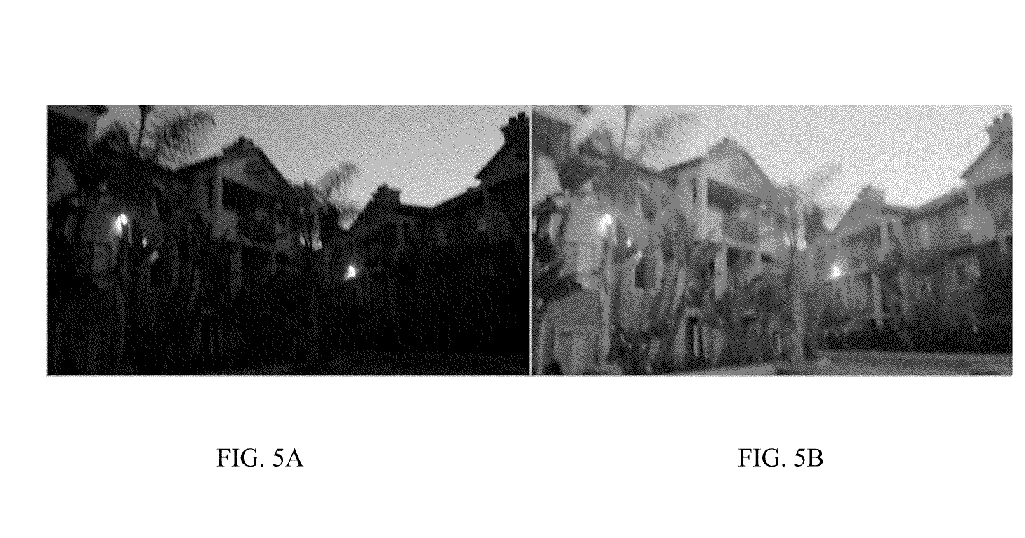

FIG. 5A shows an example image that is captured with a regular camera in low-light a condition. As shown, the image in FIG. 5A is very dark and details in the image are not visible. FIG. 5B shows the corresponding image after being processed with the image enhancing technique as described herein. As shown, the image in FIG. 5B is much brighter and details in the image are visible.

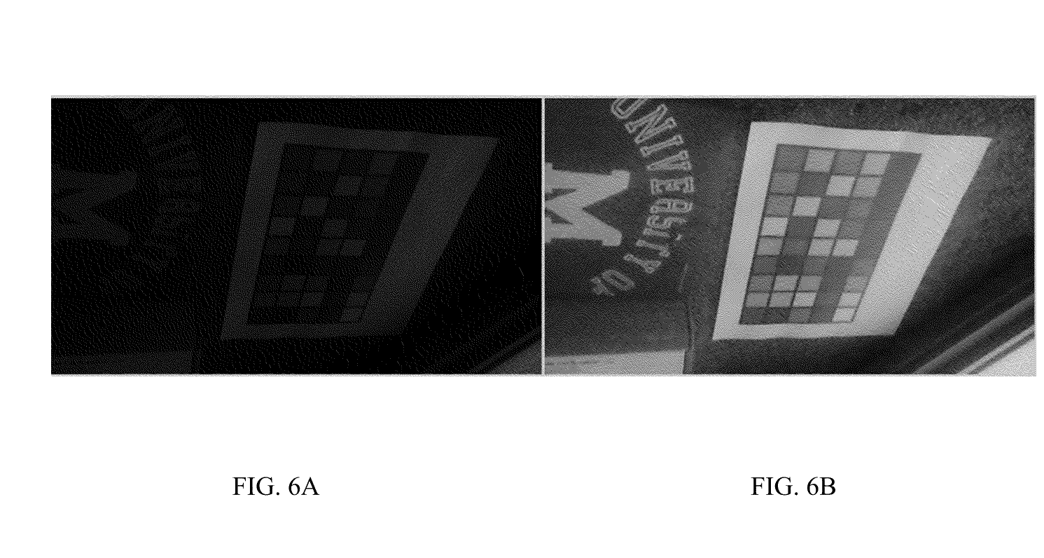

FIG. 6A shows another example image that is captured with a regular camera in low-light a condition. FIG. 6B shows an image that is processed with the image quality enhancing technique described herein. Similar to FIG. 5A, details in FIG. 6A are not visible. However, the processed image (e.g., FIG. 68) is much brighter and details are visible.

Techniques for enhancing quality of images and/or videos captured in low-lights environments are described. In one embodiment, an image is brightened and de-noised such that the details in the image are more visible, without increasing the noise level. As a result, one may capture videos in low-light environments and process them later to enhance their quality. These techniques enable capturing low cost videos and/or images in low light environments.

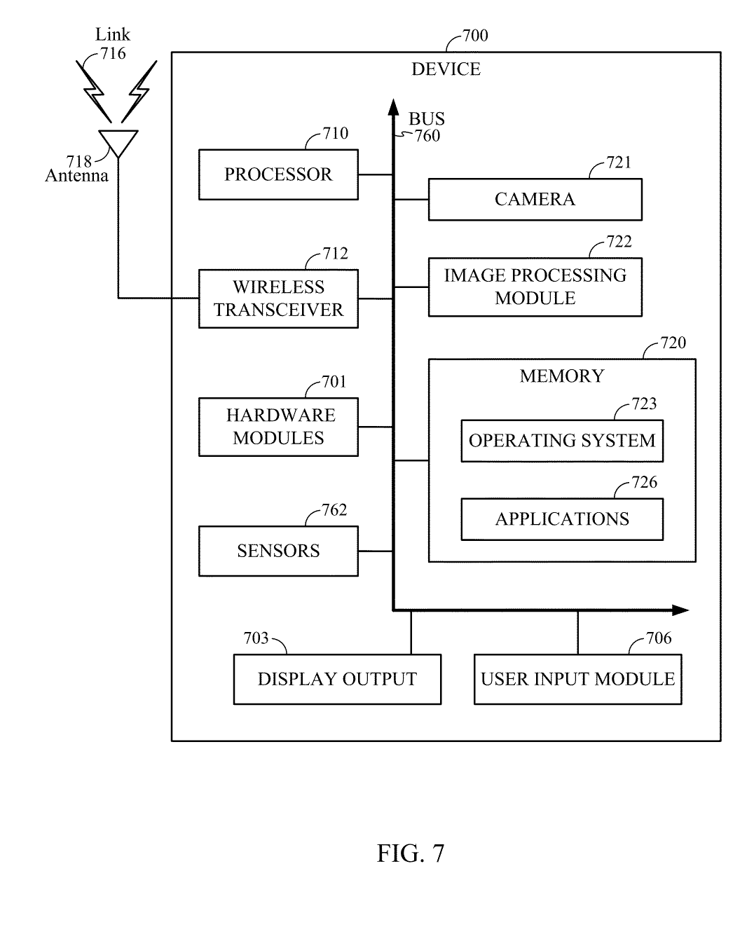

FIG. 7 describes one potential implementation of a device 700 which may be used to enhance quality of images and/or videos, according to certain embodiments. In one embodiment, device 700 may be implemented with the specifically described details of process 400. In one embodiment, specialized modules such as camera 721 and image processing module 722 may include functionality needed to capture and process images according to the method. The camera 721 and image processing modules 722 may be implemented to interact with various other modules of device 700. For example, the processed image may be output on display output 703. In addition, the image processing module may be controlled via user inputs from user input module 706. User input module 706 may accept inputs to define a user preferences regarding the enhanced image. Memory 720 may be configured to store images, and may also store settings and instructions that determine how the camera and the device operate.

In the embodiment shown at FIG. 7, the device may be a mobile device and include processor 710 configured to execute instructions for performing operations at a number of components and can be, for example, a general-purpose processor or microprocessor suitable for implementation within a portable electronic device. Processor 710 may thus implement any or all of the specific steps for operating a camera and image processing module as described herein. Processor 710 is communicatively coupled with a plurality of components within mobile device 700. To realize this communicative coupling, processor 710 may communicate with the other illustrated components across a bus 760. Bus 760 can be any subsystem adapted to transfer data within mobile device 700. Bus 760 can be a plurality of computer buses and include additional circuitry to transfer data.

Memory 720 may be coupled to processor 710. In some embodiments, memory 720 offers both short-term and long-term storage and may in fact be divided into several units. Short term memory may store images which may be discarded after an analysis. Alternatively, all images may be stored in long term storage depending on user selections. Memory 720 may be volatile, such as static random access memory (SRAM) and/or dynamic random access memory (DRAM) and/or non-volatile, such as read-only memory (ROM), flash memory, and the like. Furthermore, memory 720 can include removable storage devices, such as secure digital (SD) cards. Thus, memory 720 provides storage of computer readable instructions, data structures, program modules, and other data for mobile device 700. In some embodiments, memory 720 may be distributed into different hardware modules.

In some embodiments, memory 720 stores a plurality of applications 726. Applications 726 contain particular instructions to be executed by processor 710. In alternative embodiments, other hardware modules may additionally execute certain applications or parts of applications. Memory 720 may be used to store computer readable instructions for modules that implement scanning according to certain embodiments, and may also store compact object representations as part of a database.

In some embodiments, memory 720 includes an operating system 723. Operating system 723 may be operable to initiate the execution of the instructions provided by application modules anchor manage other hardware modules as well as interfaces with communication modules which may use wireless transceiver 712 and a link 716. Operating system 723 may be adapted to perform other operations across the components of mobile device 700, including threading, resource management, data storage control and other similar functionality.

In some embodiments, mobile device 700 includes a plurality of other hardware modules 701. Each of the other hardware modules 701 is a physical module within mobile device 700. However, while each of the hardware modules 701 is permanently configured as a structure, a respective one of hardware modules may be temporarily configured to perform specific functions or temporarily activated.

Other embodiments may include sensors integrated into device 700. An example of a sensor 762 can be, for example, an accelerometer, a Wi-Fi transceiver, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the sensors 762 may be implemented as hardware, software, or firmware. Further, as described herein, certain hardware modules such as the accelerometer, the GPS module, the gyroscope, the inertial sensor, or other such modules may be used in conjunction with the camera and image processing module to provide additional information. In certain embodiments, a user may use a user input module 706 to select how to analyze the images.

Mobile device 700 may include a component such as a wireless communication module which may integrate antenna 718 and wireless transceiver 712 with any other hardware, firmware, or software necessary for wireless communications. Such a wireless communication module may be configured to receive signals from various devices such as data sources via networks and access points such as a network access point. In certain embodiments, compact object representations may be communicated to server computers, other mobile devices, or other networked computing devices to be stored in a remote database and used by multiple other devices when the devices execute object recognition functionality.

In addition to other hardware modules and applications in memory 720, mobile device 700 may have a display output 703 and a user input module 706. Display output 703 graphically presents information from mobile device 700 to the user. This information may be derived from one or more application modules, one or more hardware modules, a combination thereof, or any other suitable means for resolving graphical content for the user (e.g., by operating system 723). Display output 703 can be liquid crystal display (LCD) technology, light emitting polymer display (LPD) technology, or some other display technology. In some embodiments, display module 703 is a capacitive or resistive touch screen and may be sensitive to haptic and/or tactile contact with a user. In such embodiments, the display output 703 can comprise a multi-touch-sensitive display. Display output 703 may then be used to display any number of outputs associated with a camera 721 or image processing module 722, such as alerts, settings, thresholds, user interfaces, or other such controls.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner.

Specific details are given in the description to provide a thorough understanding of the embodiments. However, embodiments may be practiced without certain specific details. For example, well-known circuits, processes, algorithms, structures, and techniques have been mentioned without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes which may be depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Additionally, the above elements may merely be a component of a larger system, wherein other rules may take precedence over or otherwise modify the application of various embodiments, and any number of steps may be undertaken before, during, or after the elements of any embodiment are implemented.

It should be noted that the method as described herein may be implemented in software. The software may in general be stored in a non-transitory storage device (e.g., memory) and carried out by a processor (e.g., a general purpose processor, a digital signal processor, and the like.)

Having described several embodiments, it will therefore be clear to a person of ordinary skill that various modifications, alternative constructions, and equivalents may be used without departing from the spirit of the disclosure.

What is claimed is:

1. A method for enhancing quality of a first image that is captured in a low-light environment, comprising:
generating a second image by brightening a plurality of pixels in the first image based on a predefined criteria; and
generating a third image using an edge-preserving noise reduction algorithm based on the second image.

2. The method of claim 1, further comprising:
generating a composite image by calculating a weighted average of the first image and the third image.

3. The method of claim 2, further comprising:
calculating at least one weight corresponding to each pixel based on average intensity in a neighborhood around the pixel in the first image, wherein the at least one weight is used in the weighted average of the first image and the third image.

4. The method of claim 3, wherein the at least one weight is calculated based on a monotonically increasing function of the average intensity in the neighborhood around the pixel, and the at least one weight has a value between zero and one.

5. The method of claim 4, wherein the at least one weight is calculated for pixels taken from a fourth image, wherein the fourth image is generated by at least one of blurring and downsizing the first image.

6. The method of claim 1, wherein the predefined criteria comprises one or more look-up tables for mapping at least one of color or brightness values of the first image to the second image.

7. The method of claim 6, wherein the first image comprises a plurality of first images and the one or more look-up tables are adapted for each of the plurality of first images based on brightness of an input scene.

8. The method of claim 1, wherein generating the third image comprises:
generating an edge map of the second image; and
generating the third image by obtaining a weighted average of the second image and a fourth image based at least on the edge map, wherein the fourth image is generated by blurring the second image.

9. The method of claim 8, further comprising:
for each pixel in the second image, determining a weight corresponding to the second image based on the edge map, wherein the weight is larger than 0.5 if the pixel represents an edge, and the weight is smaller than 0.5 if the pixel is part of a smooth area in the second image.

10. An apparatus for enhancing quality of a first image that is captured in a low-light environment, comprising:
means for generating a second image by brightening a plurality of pixels in the first image based on a predefined criteria; and
means for generating a third image using an edge-preserving noise reduction algorithm based on the second image.

11. The apparatus of claim 10, further comprising:
means for generating a composite image by calculating a weighted average of the first image and the third image.

12. The apparatus of claim 11, further comprising:
means for calculating at least one weight corresponding to each pixel based on average intensity in a neighborhood around the pixel in the first image, wherein the at least one weight is used in the weighted average of the first image and the third image.

13. The apparatus of claim 12, wherein the at least one weight is calculated based on a monotonically increasing function of the average intensity in the neighborhood around the pixel, and the at least one weight has a value between zero and one.

14. The apparatus of claim 13, wherein the at least one weight is calculated for pixels taken from a fourth image, wherein the fourth image is generated by at least one of blurring and downsizing the first image.

15. The apparatus of claim 10, wherein the predefined criteria comprises one or more look-up tables for mapping at least one of color or brightness values of the first image to the second image.

16. The apparatus of claim 15, wherein the first image comprises a plurality of first images and the one or inure look-up tables are adapted for each of the plurality of first images based on brightness of an input scene.

17. The apparatus of claim 10, wherein the means for generating the third image comprises:
means for generating an edge map of the second image; and
means for generating the third image by obtaining a weighted average of the second image and a fourth image based at least on the edge map, wherein the fourth image is generated by blurring the second image.

18. The apparatus of claim 17, further comprising:
for each pixel in the second image, means for determining a weight corresponding to the second image based on the edge map, wherein the weight is larger than 0.5 if the pixel represents an edge, and the weight is smaller than 0.5 if the pixel is part of a smooth area in the second image.

19. A non-transitory processor-readable medium for enhancing quality of a first image that is captured in a low-light environment comprising processor-readable instructions configured to cause a processor to:
generating a second image by brightening a plurality of pixels in the first image based on a predefined criteria; and
generating a third image using an edge preserving noise reduction algorithm based on the second image.

20. The processor-readable medium of claim 19, further comprising:
generating a composite image by calculating a weighted average of the first image and the third image.
